(19) United States
(12) Patent Application Publication
(10) Pub. No.: US 2008/0243805 A1
(43) Pub. Date: Oct. 2, 2008

(54) Automatic Creation of E-Books

(76) Inventors: Srinivas Gutta, Velbhoven (NL); Wilhelmus Franciscus Johannes Verhaegh, Eindhoven (NL); Petrus Gerardus Meuleman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/586,703

(22) PCT Filed: Jan. 17, 2005
(86) PCT No.: PCT/IB05/50186

§ 371 Date: Jul. 20, 2006

Related U.S. Application Data
(60) Provisional application No. 60/537,810, filed on Jan. 20, 2004.

(51) Int. Cl. G06F 7/06; G06F 17/30; G06Q 30/00

(52) U.S. Cl. 707/5; 705/1; 707/E17.108

(57) ABSTRACT

A system searches for segments among multiple publications dealing with a given topic or set of topics, and compiles these segments into a custom-created electronic-book. In a commercial environment, such custom-created e-books are offered for sale to a user or set of users who have expressed interest in the given topic or set of topics. Optionally, the system is aware of the publications that are in a user's existing library, and avoids the inclusion of redundant material in the custom-created e-book for that user.

This invention relates to the field of electronic books, and in particular to a method and system for creating a customized electronic book by compiling chapters of interest to a user.

Electronic books (e-books) are becoming increasingly popular. Users are able to purchase e-books, or select portions of e-books via the Internet, or at kiosks in conventional bookstores or other venues. The purchase of select portions, or chapters, of an e-book is a particularly useful/economical option for obtaining reference material, or material of specific interest to a user. Students, for example, may purchase only the chapters of a text that the instructor references during a course. A fishing enthusiast may purchase only the chapters of a fishing book that address the fish that may be found in his or her geographic region, or only the chapters dealing with particular riggings. An art aficionado may purchase only the chapters that discuss the works of an artist, and not purchase the chapters that discuss the life of the artist.

PCT application PCT/US96/19119, WO 97/22100, discloses a system that facilitates the selection of chapters from one or more e-books to create a user-customized e-book, and is incorporated by reference herein. In this system, the user scans through the e-books and identifies chapters or pages of interest, and a new e-book containing the selected chapters or pages is created.

A manual custom e-book creation process, however, is somewhat cumbersome and inefficient, because in a typical session, the user has to find each book, scan each book, or each index or table of contents of each book, to determine whether the book contains the particular topic of interest, then scan the found pages to determine if the topic is actually discussed or merely mentioned, and so on. If the user wants to keep up to date of the particular topic, this process will typically be repeated regularly, depending upon the expected rate of publication of new material in that field of study.

It is an object of this invention to automate the creation of customized e-books. It is a further object of this invention to automate the creation of customized e-books based on a user profile. It is a further object of this invention to provide a method of increasing sales of e-books by providing customized e-books to potential customers, based on customer profiles.

These objects, and others, are achieved by providing a system that searches for segments of publications dealing with a given topic or set of topics, and compiles these segments into a custom-created e-book. In a commercial environment, such custom-created e-books could be offered for sale to a user or set of users who have expressed interest in the given topic or set of topics. Optionally, the system is aware of the publications that are in a user's existing library, and avoids the inclusion of redundant material in the custom-created e-book for that user.

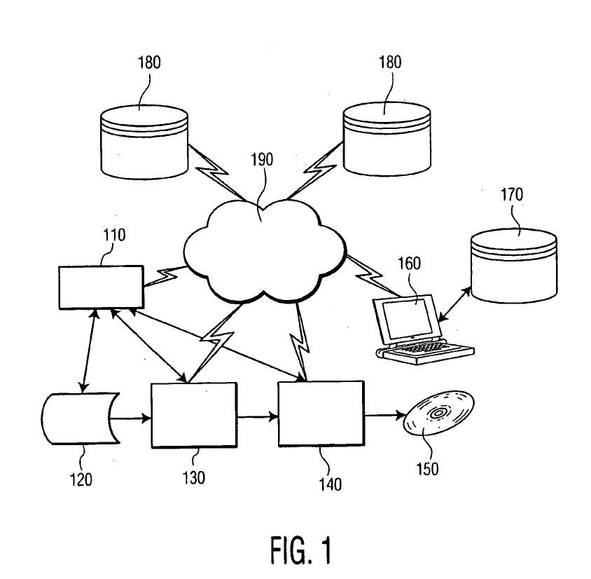

FIG. 1 illustrates an example block diagram of an e-book creation system in accordance with this invention.

This invention is presented using the paradigm of a provider of information from one or more publishers to a user. The provider of the information may be, for example, an on-line bookstore, a conventional bookstore with a kiosk, and so on. The one or more publishers include parties authorized to distribute e-books or portions of e-books, or any form of published material. Upon review of this disclosure, one of ordinary skill in the art will recognize that other applications and configurations of this invention are possible, including the installation and use of the system at a user's location, obviating the need for a third-party provider, as well as other applications and configurations.

FIG. 1 illustrates an example block diagram of an e-book creation system 100 in accordance with this invention. A searcher 130 is configured to search for segments of publications dealing with one or more topics, based on a user profile 120. A network 190 provides the searcher 130 with access to one or more databases of publications 180. For the purposes of this invention, the term database includes any collection of material that facilitates access to the material, and includes, for example, one or more web-pages that contain published material.

When the searcher 130 locates a segment of a publication, it provides an identifier of the segment to a compiler 140. The compiler 140 is configured to combine one or more of the segments identified by the searcher 130 into an e-book, which is illustrated as a disk 150, although it could exist in any form, including a ‘virtual e-book’ that is not actually put into a compiled form until it is downloaded to the user. Preferably, the searcher 130 also provides ancillary information that facilitates the potential selection of each segment by the compiler, including, for example, the size of the segment, a match-measure that indicates the degree of correspondence between the material in the segment and the search criteria, a quality-measure that is based on the source of the material, a cost-factor that indicates a relative cost of the segment, and so on.

A manager 110 is configured to provide the user profile 120 to the searcher, and to offer the compiled e-book from the compiler 140 to the user, illustrated by a user terminal 160. In a preferred embodiment of this invention, the manager 110 creates the user profile 120 based initially on the user's response to explicit questions, or explicit selections, regarding the user's topic or topics of interest. For example, if the user is a fisherman, the user's topics of interest may include the topics of ‘rigging’ and ‘casting’. The user has the option of deciding whether multiple topics are contained in a single profile, or whether a separate profile is provided for each topic. If the user includes both rigging and casting in the user's profile, the resultant e-books will likely contain segments dealing with rigging or casting, or both. A user may have many profiles, with any combination of single or multiple topics. Thereafter, the manager 110 in a preferred embodiment is configured to modify and refine the user's profile based on the subsequent experiences with the user, using machine-learning techniques, common in the art. The user is also provided the option of maintaining a fixed profile, or a combination of fixed and machine-changeable profiles. Any of a variety of techniques may be used to identify the topic or topics of interest, including the identification of keywords, Boolean connectives among keywords, identification of previously acquired publications or segments of publications, and so on.

The searcher 130 is preferably embodied as a “web-crawler”, using techniques common in the art to scan web-sites to locate sites that contain material corresponding to the user's profile. Depending upon the particular embodiment, the manager 110 may merely present the list of topics in the user profile 120 for the searcher 130 to use, or the manager 110 may work in combination with the searcher 130, and perform such tasks as forming a search phrase based on the profile 120, refining the search phrase based on search results, and so on.

Similarly, the manager 110 may work in concert with the compiler 140 to select identified segments for inclusion in the custom-created e-book. In a preferred embodiment of this invention, the manager 110 also collects information from the user regarding preferences for the selection and compilation process. The user may specify a maximum length of each individual segment, a maximum word-per-figure ratio, a maximum cost-per-page ratio, and so on. The user may also specify particular authors, editors, publishers, etc. for inclusion or exclusion, the age of the publication, the language, and so on. Depending upon the particular embodiment, some or all of these selection criteria may be incorporated into the searcher 130, or a separate selector module, not shown, can be used.

Optionally, the manager 110 is aware of the user's current collection of publications, represented as a database 170. The user is provided the option of explicitly informing the manager 110 of any existing publications in the user's collection. Additionally, the manager 110 maintains a record of the contents of the e-books that the manager 110 has thus far provided to the user, and, as discussed further below, if a user identifies a segment in an offered e-book as “I already have”, the manager 110 maintains this information as well. The compiler 140 and/or the searcher 130, in conjunction with the manager 110, are configured to exclude any segments that are currently known to be in the user's collection from future e-books, unless otherwise directed by the user.

To provide a truly custom-designed compilation, the user is also provided the opportunity of specifying a preferred font, a preferred display page size, whether to include an index or table of contents, or both, whether to consolidate any references cited in the segments to form a single reference section, and so on.

When the e-book is compiled, or ‘virtually compiled’ as discussed above, the manager 110 is configured to contact the user at 160 to offer this custom-designed e-book. Preferably, the manager provides a table of contents, and allows the user to preview the selected segments. The user has the option of removing segments from the offered collection, and can provide one or more reasons for the removal, to facilitate future selections. For example, as noted above, the user can identify material that the user already possesses. The user may identify material as being too detailed, or not detailed enough, or outdated, and so on, and the system can apply machine learning techniques to filter similar material in the future. Similarly, the user may merely indicate a “thumbs up” or “thumbs down”, and the system builds a knowledge base to determine trends in the user's likes and dislikes.

If the user chooses to acquire the e-book, the manager 110 provides the e-book to the user, either by shipping the e-book on a physical medium 150, or by transferring the e-book electronically via the network 190, or a combination of both, typically for a fee. If there are costs associated with acquiring the segments from the databases 180, the fee includes these costs, and the provider of the e-book reimburses the providers of the databases 180 for the provided segments. If the system 100 is located on the user's system 160, avoiding the third-party provider of the e-book, the system 100 is configured to effect a transfer of funds directly to the providers of the databases 180 for the acquired segments. The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented above using a profile of a single user, commercial concerns may find it beneficial to create somewhat generic user profiles, and offer the resultant e-books to customers who appear to fit each profile. The profiles may also be used in a hierarchical fashion, wherein a generic profile is used to find a collection of segments, and an individual profile may be used to filter the collection to form an individualized selection, thereby optimizing the search time by finding segments that are likely to be of interest to groups of users, then searching only through these segments for each individual in the group. In like manner, the generic profiles can form a multi-tiered hierarchy to further optimize the search process. These and other system configuration and optimization features will be evident to one of ordinary skill in the art in view of this disclosure, and are included within the scope of the following claims.

1. An e-book system comprising:
a searcher that is configured to locate segments of a plurality of publications based on a user profile,
a compiler, operably coupled to the searcher, that is configured to create an e-book from the segments.

2. The e-book system of claim 1, further including:
a manager that is configured to create the user profile, based on interactions with a user.

3. The e-book system of claim 1, wherein
the system is further configured to notify a user of the e-book that is created by the compiler.

4. The e-book system of claim 3, wherein
the system is further configured to effect a transfer of the e-book to the user.

5. The e-book system of claim 4, wherein
the transfer is effected in exchange for payment by the user.

6. The e-book system of claim 1, wherein
the system is configured to modify the user profile based on subsequent activities of a user.

7. The e-book system of claim 1, wherein
the system is further configured to modify the e-book, based on selections by a user.

8. The e-book system of claim 1, wherein
the searcher is configured to search Internet sites to locate the segments.

9. The e-book system of claim 1, wherein
the compiler is configured to format the e-book based on preferences of a user.

10. The e-book system of claim 1, wherein
the user profile corresponds to a profile of a generic user.

11. The e-book system of claim 1, wherein
the searcher is further configured to locate the segments of publications based on a hierarchy of user profiles.

12. The e-book system of claim 1, wherein
the user profile includes at least one of:
a topic of interest,
a keyword,
an author, and
a publisher.

13. The e-book system of claim 11, wherein
the user profile further includes at least one of:
a maximum segment length,
a maximum complexity level, and
a maximum text-to-figure ratio.

14. The e-book system of claim 1, wherein
the user profile includes an identification of segments that are already possessed by a user.

15. The e-book system of claim 1, wherein
the compiler is further configured to filter the segments to provide select segments corresponding to the user profile in the e-book.

16. A method of creating an e-book comprising:
searching among a plurality of publications for segments corresponding to a user profile,
compiling some or all of the segments to create the e-book.

17. The method of claim 16, further including
creating the user profile based on interactions with a user.

18. The method of claim 16, further including
creating the user profile based on determined preferences of a class of users.

19. The method of claim 16, further including
offering the e-book for sale.

20. The method of claim 16, further including
modifying the e-book, based on interactions with a user.

21. The method of claim 16, further including
modifying the user profile, based on activities of one or more users.
